(19) United States
(12) Patent Application Publication
(10) Pub. No.: US 2003/0163514 A1
(43) Pub. Date: Aug. 28, 2003

(54) Methods and systems for integrating dynamic polling mechanisms into software applications

(75) Inventor: Eric J. Waldschmidt, Verbank, NY (US)

Correspondence Address: LAW OFFICE OF BARRY R LIPSITZ, 755 MAIN STREET, MONROE, CT, 06468, US

(73) Assignee: BrandFact, Inc., Verbank, NY

(21) Appl. No.: 10/366,232

(22) Filed: Feb. 13, 2003

Related U.S. Application Data
(60) Provisional application No. 60/358,583, filed on Feb. 22, 2002.

(51) Int. Cl. G06F 15/16

(52) U.S. Cl. 709/201

(57) ABSTRACT

Methods and systems for integrating dynamic polling mechanisms into software applications are provided. A poll engine accessible via a communication network is provided which has a database for storing polling information. An interactive software application has a poll command inserted at one or more poll points. Each poll point is defined by a respective interaction step of the software application. A browser enables a user to access the interactive software application via the network. A processor associated with the browser generates a poll request message in response to interaction with the software application at the poll point and communicates the poll request message to the poll engine via the network. A poll processor associated with the poll engine is provided which generates a poll in response to the poll request message and communicates the poll to the browser.

This application claims the benefit of U.S. provisional patent application No. 60/358,583 filed on Feb. 22, 2002.

### BACKGROUND OF THE INVENTION

The present invention relates generally to methods and systems for measuring the opinions of a specific group of individuals. More specifically, the present invention relates to methods and systems for integrating dynamic polling mechanisms into software applications in order to poll users of that software and measure their responses to those polls over a communication network, such as the Internet.

Most organizations consider information regarding the opinions (i.e. the satisfaction, perceptions, expectations, etc.) of their customers, employees, partners, suppliers, prospects, industry analysts, financial analysts, press representatives or any other target audience they may deem appropriate, as vital to the ongoing successful operation of the organization.

Accurate and current information regarding the opinions of these important target audiences is known to be a reliable leading indicator of future organizational performance and most often a better predictor than lagging indicators such as sales results. For example, customer satisfaction regarding the quality of a specific product is a better gauge of its future sales potential than its most recent sales volumes. Therefore, organizations often seek to gather information regarding these opinions in a reliable and timely manner.

With the continuing development of the Internet and other on-line networks, many companies today provide software products for the purposes of conducting surveys of a specific audience. Typically, these products facilitate the creation and execution of a survey process through a variety of formats, including via Web (initiated via a pop-up window or a hyperlink), email, phone, fax and/or mail.

Currently, all of the available products require the target user to initiate a separate and non-trivial procedure to participate in the survey, which most likely limits participation and can, in some cases, be an annoyance to the target user. Many target users are reluctant to participate in surveys because they believe that the time required to complete such a process is not compensated with an equal benefit. They are either unwilling to spend the time to respond to the survey or feel their input will not be acted upon and therefore their effort wasted. Furthermore, if the target user does decide to participate, all except the software survey products employing the Web format allow the target user to postpone participation, well past the point of interaction. This can affect the validity of the response data, as a target user may have difficulty accurately recalling the details of the interaction some time later.

Another disadvantage of the prior art is that gathering new response information requires the initiation of a new process to invite participation in the survey. Surveys initiated through email, phone, fax or mail will no longer gather new response data beyond a relatively short period after the invitations have been sent. After this response period, no new information is collected unless another invitation process is conducted.

In addition, the level of perceived effort and time required to respond to surveys makes it impractical to survey an individual more than two to four times a year without the risk of annoying them significantly. Therefore, without a continuous stream of new responses, the data becomes a less meaningful measurement of current opinions.

Because of these limitations, companies often have outdated information, or the results may be skewed by the higher participation of those on either extreme of the opinion spectrum.

Therefore, it would be highly desirable for an organization to have a mechanism to continuously gather opinion responses from a specified group of individuals during interactions that the individuals initiate with the organization, and in a manner that:

Does not require the individuals to initiate a separate process;

Requires only minimal effort on the part of the individuals (i.e. one or two mouse clicks);

Is voluntary on the part of the target user;

Integrates the poll into the interaction process initiated by the individuals;

Provides control over which specific poll, if any, is displayed to the individuals;

Provides control over what step(s) in the interaction process a poll should appear;

Continuously gathers new response information as new interactions with the individuals occur;

Allows modifications to the poll questions to be asked of the individuals, or the criteria used to select the poll questions to be presented to the individuals—without additional alteration to the mechanism controlling the interaction; and

Requires only a one-time generic alteration to the mechanism (e.g., a computer software application) controlling the interaction.

A mechanism having the foregoing specifications would allow an organization to obtain real-time continuous macro-level measurements of the opinions of a specified audience. The organization can then use the measurements to initiate, as warranted, additional communications using techniques already available under the prior art (e.g., follow-up surveys, personal telephone contact, and the like). The information can also be useful to organizations as a gauge of the validity or potential of a particular business strategy, financial/operating plans, product plans, marketing programs, employee programs, partner programs, and the like.

Therefore, it is one object of the present invention to provide a dynamic polling mechanism that can be integrated into existing computer software applications with a onetime generic programming code alteration. It is another object of the present invention to provide control over the specific points within an interaction that a poll is to be incorporated. It is a further object of the present invention to provide control over the specific poll generated for each interaction without additional alteration to the software application. It is an additional object of the present invention to provide the capability to accumulate the responses so that they can be analyzed using any number of data analysis techniques commonly available and in use today. It is a still further object of the present invention to accumulate each target user's response patterns to further refine poll selection criteria for each target user. It is another object of the present invention to track the opinions of a target audience over time using a single question poll at distinct poll points in an interaction process rather than a multi-question survey at a single point in time. It is also an object of the present invention to provide a polling process that does not require the initiation of a separate process by the user. It is an object of the present invention to enable a user to respond to a poll with minimal effort and inconvenience.

The methods and systems of the present invention provide the foregoing and other advantages.

### SUMMARY OF THE INVENTION

The present invention relates to methods and systems for integrating dynamically generated polls at specified points within any interaction process controlled by a software application without significantly altering that application. Responses of the target user to these polls and their historical response patterns are collected and used to refine the poll selection criteria for each target user. The location of the target user within the interaction process, the target user poll selection criteria and the poll attributes are used to select the poll to be presented to the target user at the predetermined points in the interaction process.

As used herein, the term “poll” refers to a single question to which multiple choice answers are provided. In contrast, a “survey” contains multiple questions.

In accordance with the invention, an organization wishing to measure opinions identifies the group of individuals to be polled (also referred to herein as target users) and then considers all the processes these individuals use to interact with the organization along with the step(s) within these processes where a poll should be conducted. Next, the questions that are to be asked at these steps are developed.

To effect the polling capability, a poll engine is provided as an addressable resource on a network such as the Internet. The organization stores, on this resource, information regarding the individuals to be polled, the poll questions to be asked and the specific steps within the interaction processes where a poll should appear.

The organization then makes a simple modification to the software applications currently used to control these interaction processes by placing one line of programming code that is designed to request a poll at each of the specified interaction points within the software applications.

When one of the individuals to be polled, either directly or indirectly, accesses one of these software applications and reaches a step in the interaction process that has been altered to provide a poll, a poll request message is automatically generated by the device (e.g. a web browser) accessing the software application and sent to the poll engine. Since standard Internet communication protocols automatically include information regarding the individual and the software application they are accessing, it is possible to uniquely identify the individual and the current location of the individual within that application.

The poll engine will use the information stored by the polling organization regarding the polls allowed, as well as the individual's identity and location within the software application to select the appropriate poll to provide. The poll engine then provides the commands necessary to communicate and present the correct poll to the individual within the software application.

If the individual decides to respond to the poll, their response is automatically logged. By storing each individual's responses, along with the number of times they have been sent polls and their historical response patterns to other polls, the poll engine can refine the criteria it uses to select future polls for this individual. The responses are then available to the organization conducting the polls to view and analyze on a continuous basis.

### BRIEF DESCRIPTION OF THE DRAWINGS

The present invention will hereinafter be described in conjunction with the appended drawing figures, wherein like numerals denote like elements, and:

FIG. 1 shows a block diagram of an example embodiment of the invention;

FIG. 2 shows a block diagram of a further embodiment of the invention;

FIG. 3 shows a process flowchart of an example embodiment of the invention;

FIG. 4 shows a process flowchart of a poll request and selection process in accordance with an example embodiment of the invention;

FIG. 5 shows a process flowchart of a poll response process in accordance with an example embodiment of the invention; and

FIG. 6 shows an example of the tables maintained in the poll engine database in accordance with an example embodiment of the invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

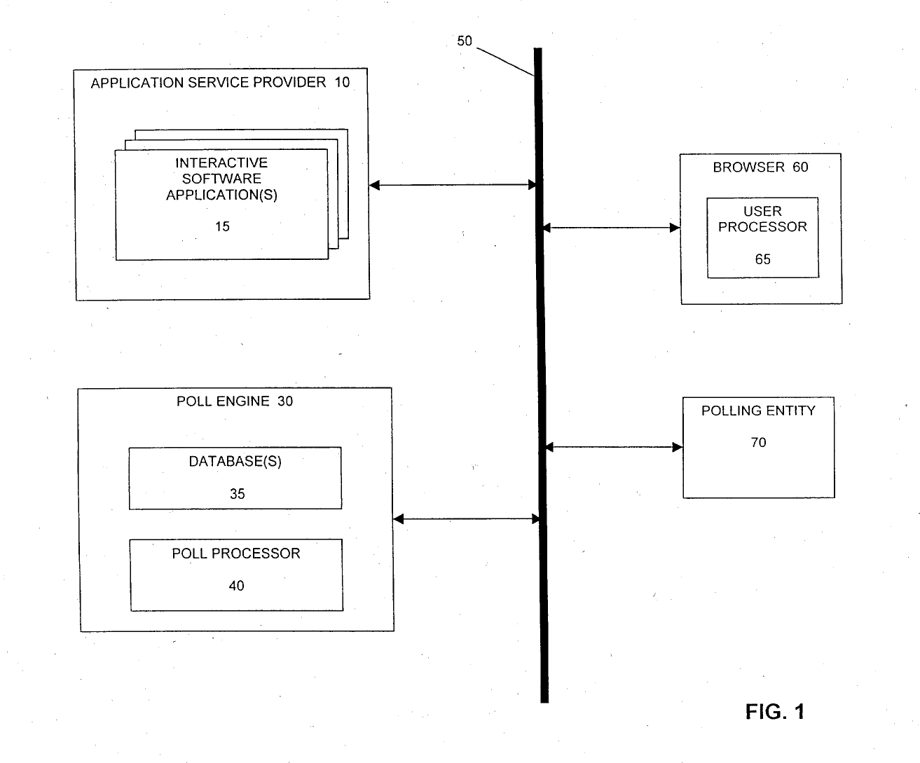

The present invention provides methods and systems for integrating dynamic polling mechanisms into software applications. As shown in FIG. 1, a poll engine 30 accessible via a communication network 50 is provided which has one or more databases 35 for storing polling information. An interactive software application 15 is provided (e.g., by application service provider 10) which has a poll command inserted at one or more poll points. Each poll point is defined by a respective interaction step of the software application 15. A browser 60 enables a target user to access the interactive software application 15 via the communication network 50. A user processor 65 associated with the browser 60 generates a poll request message in response to user interaction with the software application 15 at the one or more poll points and communicates the poll request message to the poll engine 30 via the communication network 50. A poll processor 40 associated with the poll engine 30 is provided for generating a poll in response to the poll request message and communicating the poll to the browser 60 via the communication network 50.

The poll may comprise any type of question. For example, the poll may be a question related to the interactive software application 15, a question related to the particular interaction step identified by the poll point of the software application 15, a question unrelated to the software application 15, a question related to goods or services being purchased via the software application 15, a question directed to the target user based on stored user information or previous poll responses, and the like.

The poll command may comprise a markup language compatible with the browser 60, such as HTML (hypertext markup language), XML (extensible markup language), WML (wireless markup language), or the like. An example of a poll command rendered in HTML may be written as follows:

<table><tr><td><iframe src=“http://www.BrandFact.com/start.poll” width=160 height=300 frameborder=0/></td></tr></table>

where the poll engine 30 is the resource listed between the quotation marks following the src=characters (i.e. http://www.BrandFact.com/start.poll).

Those skilled in the art will appreciate that the communication network 50 may comprise a global communication network, the Internet, a wide area network, a local area network, an intranet, or the like, including a combination of various types of networks.

The polling information may include at least one of poll titles, poll questions, poll formatting information, possible responses to the poll questions, target user types for each poll, location of a resource containing information identifying each target user, user information, a counter indicating a number of times the poll is served and the number of poll responses received, the poll points at which particular poll questions should appear, or similar information.

The browser 60 may communicate user responses to the poll to the poll engine 30, which may store the responses (e.g., in database 35). The poll engine 30 may store at least one of the content of the poll response, the identity of the user, target user IP address, poll response, identity of the polling entity, identity of the poll, date and time of the poll response, user comments, or the like.

The poll processor 40 may analyze the responses to the polls and may generate reports comprising poll results.

The poll engine 30 may comprise a plurality of databases 35, each of which is associated with a respective polling entity 70 (also referred to herein as “poller”) and each of which contains polling information provided by the respective polling entity 70. Those skilled in the art will appreciate that the polling entity 70 and the application service provider 10 may be separate entities as shown in FIG. 1. Alternatively, the polling entity 70 and the application service provider 10 may comprise a single entity.

The poll request message may include standard HTML message information, such as at least one of the Uniform Resource Locator (URL) of a page within the software application corresponding to a location of the poll point, a user cookie, a browser type, a user's logon identification, a domain of the polling entity, a target user certificate, or the like. Alternatively, the poll request message may contain XML or WML message information, or other markup language information. The poll request message may be transmitted utilizing standard http protocol (hypertext transport protocol). The poll request message is generated transparently to the user.

The poll engine 30 may generate a list of possible polls based on at least one of an identity of a polling entity, user information, a poll expiration date, poll point location, or the like.

The poll engine 30 may query response records of the user to determine the user's response history regarding any previous polls responded to by that user. The poll engine 30 may select a specific poll from the list of possible polls to communicate to the user based on the response history. The selection of the specific poll may be based on at least one of the user's specific response to previous polls, the user's overall response rate, the user's response rate to particular polls, a least served poll, poll expiration date, or the like.

A serve record (also referred to herein as “serve table”) may also be stored at the poll engine 30. The serve record may comprise at least one of an identity of the poll served, the identity of the target user, date and time of poll, poll point identification, an IP address of target user, or the like.

The poll processor 40 may communicate the poll to the browser 60 by generating a command based on a browser type used by the user and based on the polling information. The poll processor 40 may then communicate the command to the browser 60.

In the event the user cannot be identified by the poll engine 30, a new record may be created for the user in the database 35. In the event the identity of the polling entity 70 cannot be determined, a generic poll may be generated and communicated to the user.

A response record (also referred to herein as “response table”) may be created in the database 35 indicating at least one of the identity of the polling entity, an identity of the poll served, poll point identification, the identity of the target user, poll response, user comments, target user IP address, date and time of the poll response, or the like.

The poll processor 40 may determine if a user is allowed to view cumulative results of the polling. If allowed, the poll processor 40 may generate a command that displays the cumulative results of the served polls on the browser 60. If not allowed, the poll processor 40 may generate a command that displays a predetermined message on the browser 60.

The polling entity 70 may also be allowed to view results of the poll. The results may be compiled from one of specific target user poll responses or a plurality of poll responses from various users.

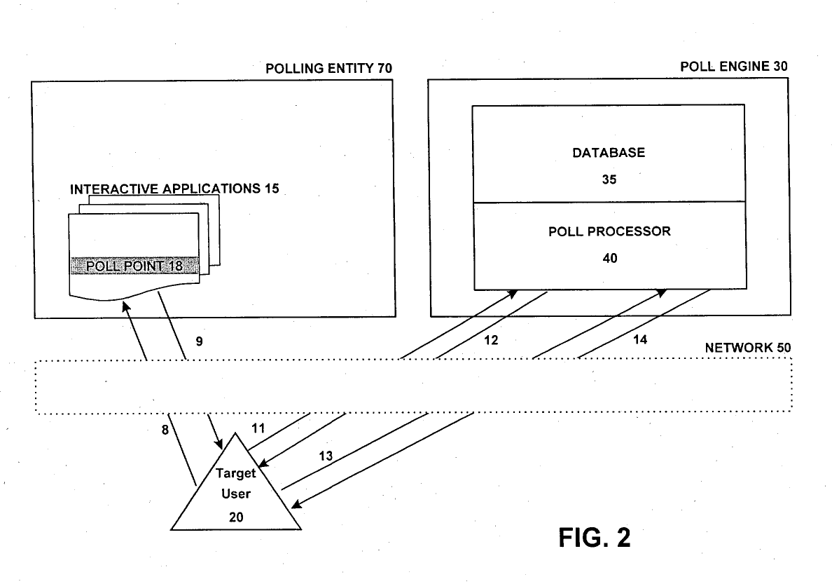

FIGS. 2-6 illustrate an example of a preferred embodiment of the invention. As illustrated in FIG. 2 the polling entity 70, needing to gauge the opinions of a specific group of individuals who interact with the polling entity 70 on a regular basis, (e.g. customers, employees, partners), hereafter referred to as “target users” 20, reviews the processes, hereafter referred to as “interaction processes”, used by the target users 20 to conduct an interaction (e.g. the purchase of goods, or a service inquiry regarding a product previously purchased, or the like) with the polling entity 70. The polling entity 70 may employ existing computer software applications, also referred to herein as “interactive applications” 15, for the purposes of controlling/guiding/documenting and executing the results of the interaction process. These interactive applications 15 may be addressable as resources on network 50.

The polling entity 70 may then determine the precise step(s) within the interaction process, and therefore the page within the interactive application 15, that a poll should be presented to the target user. Each such location is referred to herein as a “poll point” 18.

Prior to altering the interactive application 15 to include the. generic poll command at a specified poll point 18, the polling entity 70 may first store essential information regarding the polls on an information resource, referred to herein as the “poll engine” 30. The poll engine 30 may also be addressable as a resource on the network 50. This information may be stored on a database 35 within the poll engine 30 and may include, without limitation, the poll questions to be asked, the poll titles, the possible responses for each poll question, poll formatting information (such as typefaces, colors, and the like), the acceptable poll points 18 where each poll is permitted to be displayed, the types of target users 20 that can receive the polls, the location of a resource containing the information uniquely identifying each target user, and the like. In one example embodiment, the unique identifier for each target user 20 is the logon id given to them by the polling entity 70 in order to gain access to the interaction applications 18.

The polling entity 70 may then enable the polling function by including a programming command at that page in the programming code of the interaction application 15 specified by the poll point 18. The purpose of the command is simply to make a generic request for a poll from the poll engine 30.

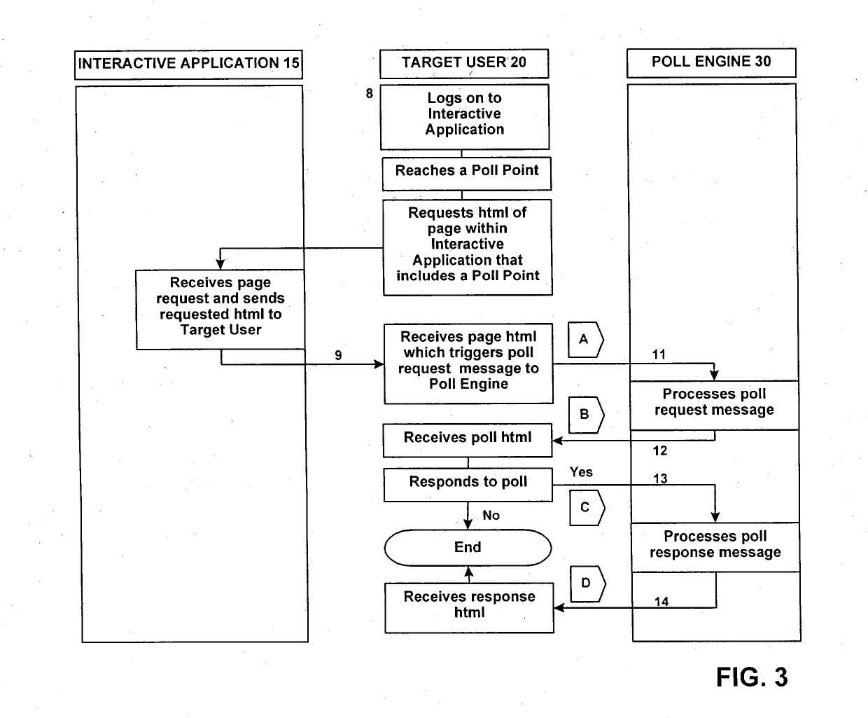

With the poll capability enabled, the target users 20 can begin receiving and respond to polls. As illustrated in the process flowchart of the example embodiment shown in FIG. 3, the target user 20 first logs on (shown as communication 8 in FIGS. 2 and 3) to the interaction application 15 using a device such as a web browser connected to the network 50 and specifically identifies him/herself using a unique logon id and password. Upon reaching the page (or URL in the specified embodiment) within the interaction application 15 that is defined as a poll point 18, the interaction application 15 may transmit the generic poll request command (shown as communication 9 in FIGS. 2 and 3) to the target user's browser within the HTML commands of that page. This will trigger the target user's browser to pass a message (shown as communication 11 in FIGS. 2 and 3) to the poll processor 40, a computer program within the poll engine 30, requesting HTML commands that will allow the target user's browser to display a poll in the space reserved by the HTML of the page for the interaction application 15.

Through messaging protocol standards such as the MIME header and environment variables, this message may include information such as the URL (in the specified example embodiment) of the page within the interaction application 15 that passed the poll request information to the target user's browser, a cookie (if present), the target user's browser type, the target user's logon id, the domain of the polling entity, a certificate (if present), and the like.

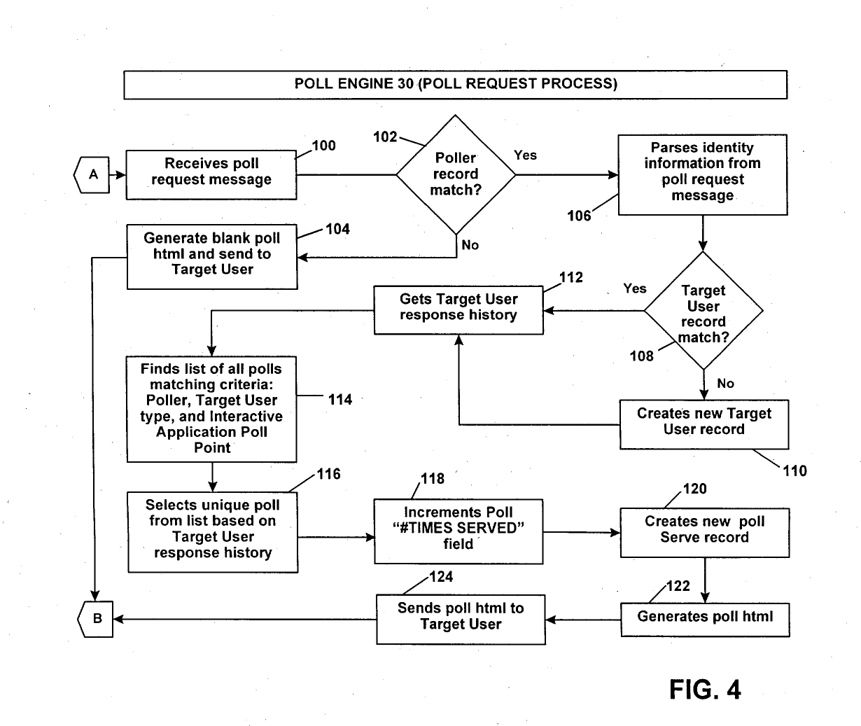

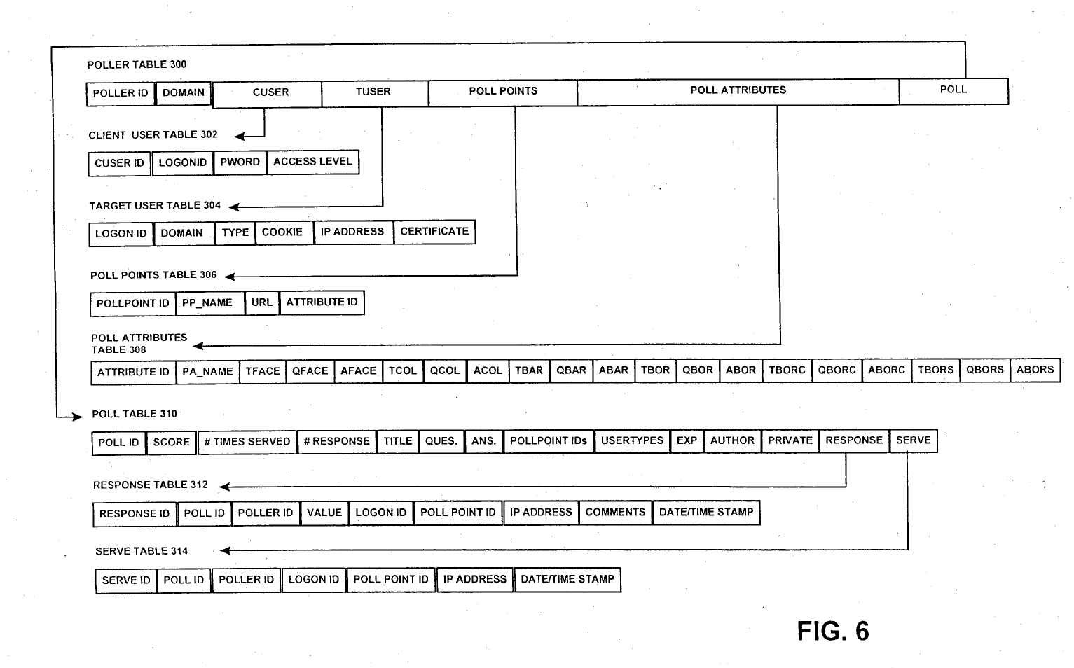

The poll processor 40 may use an exemplary process illustrated in the process flowchart shown in FIG. 4 in order to determine the correct poll to serve to the target user 20 in response to an incoming poll request message. The poll processor 40 receives the poll request message (step 100). The poll processor 40 then may determine the identity of the polling entity 70. The referring URL listed in the MIME header will indicate who the polling entity 70 is, and the poll point 18 where the target user 20 is currently located. This information indicates which tables of database 35 to query. If there is no match (step 102) of the polling entity 70 in the database 35 poller table records (shown in FIG. 6 as poller table 300) then a blank (or generic) poll may be sent to the target user (step 104).

If the polling entity 70 is recognized, the poll processor 40 may determine the identity of the target user 20 by parsing (step 106) the information contained in the MIME header and environment variables of the poll request message and checking the target user table (shown in FIG. 6 as target user table 304) to determine if there is match (step 108) for this target user's logon id. If there is no match, then a new target user record may be created (step 110) in this polling entity's target user table. If there is a match, this will indicate the target user 20 type (customer, employee, partner, etc.) The poll processor 40 next queries this polling entity's response tables (shown in FIG. 6 as response table 312) to determine the target user's response history (step 112).

The poll processor 40 may then query this polling entity's poll table (shown in FIG. 6 as poll table 310) to determine the list of possible polls that can be served (step 114):

On behalf of this polling entity 70;

To this target user 20 type;

At this poll point 18 location.

Next, any number of algorithms may be used by the poll processor 40 to select the most appropriate poll from this list of polls (step 116) to send to the target user 20. These algorithms may use the following information:

Target user's specific responses to previous polls;

Target user's response rate overall and response rates to certain types of polls;

Least served poll that matches criteria;

Expiration date of poll (if present);

Other similar information.

Once the specific poll to be sent has been selected, the poll processor 40 may increment “#times served” field (step 118) of the selected poll record in the poll table and creates a new record (step 120) in the serve table (shown in FIG. 6 as serve table 314).

The poll processor 40 may then generate html commands (step 122) using:

Target User device type from the poll request message MIME header;

Poll attributes information stored in the polling entity's poll point and poll attributes tables.

The poll processor 40 may then send the commands (step 124; also shown as communication 12 in FIGS. 2 and 3) in a message to the target user's browser which receives the poll HTML and displays the correctly formatted poll to the target user 20. If the target user 20 decides to respond to the displayed poll, another message (shown as communication 13 in FIGS. 2 and 3) is sent to the poll processor 40 including the target user's specific response to the poll.

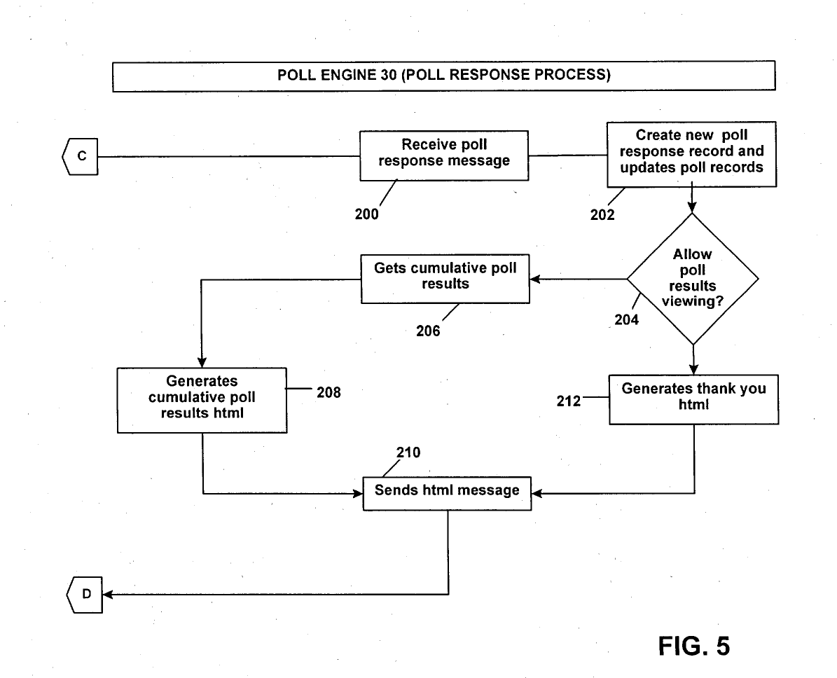

As illustrated in the process flowchart shown in FIG. 5, the poll processor 40, upon receiving the response message (step 200; also shown as communication 13 in FIGS. 2 and 3) from the target user 20, may create a new response record in that poll's response table (step 202) indicating the response ID, poll ID, polling entity ID, response, logon ID, poll point ID, IP address of target user 20, comments, and a date/time stamp (as shown in FIG. 6 as response table 312). In addition, the poll processor 40 may increment the “# response” field in the poll table record to reflect the number of responses received.

The poll processor 40 next determines if the target user 20 is allowed to view the poll results (step 204). If the “view” field in the poll table record indicates that the target user 20 can view the cumulative results of the poll, the poll processor 40 will obtain the cumulative results of the poll (step 206) and generate (step 208) and send the HTML commands (step 210; also shown as communication 14 in FIGS. 2 and 3) that will display the cumulative results of the poll in the target user's browser while replacing the display of the original poll. The poll processor 40 uses the same target user device type and poll attribute information used previously to generate the original poll HTML commands.

If the “view” field indicates that the target user 20 is not permitted to view the cumulative results, the poll processor 40 will then generate and send the HTML commands (step 212; also shown as communication 14 in FIGS. 2 and 3) that will display a “thank you” message (or similar message) in the target user's browser while replacing the display of the original poll. The poll processor 40 uses the same target user device type and poll attribute information used previously to generate the original poll HTML commands.

The polling entity 70 can view the cumulative poll responses over a secure network connection using standard database analysis and reporting techniques and currently available software to query the database of poll responses. For example, the polling entity 70 may like to monitor the response to a specific poll of a specific target user or perhaps the cumulative responses of a group of target users to a grouping of polls. This monitoring process may include the generation of alerts that notify the polling entity of responses that are outside of a pre-specified range. In addition, these responses can be monitored on a continuous basis. Ad-hoc queries of the response data can be executed to gather further detail if the alerts warrant further investigation. Regular reports can be communicated on a scheduled basis.

It should now be appreciated that the present invention provides advantageous methods and apparatus for integrating dynamic polling mechanisms into interactive software applications with a one-time generic programming code alteration. Further, the present invention provides control over the specific points within an interactive application that a poll is incorporated, as well as control over the specific poll generated for each interaction, without additional alteration to the software application. Poll responses can be accumulated so that they can be analyzed using any number of data analysis techniques. Poll response patterns can be utilized to further refine poll selection criteria for each target user. The opinions of a target audience can be tracked over time using a single question poll at distinct poll points in an interaction process rather than a multi-question survey at a single point in time. The polling process advantageously does not require the initiation of a separate process by the user. The present invention also enables a user to respond to a poll with minimal effort and inconvenience.

Although the invention has been described in connection with various illustrated embodiments, numerous modifications and adaptations may be made thereto without departing from the spirit and scope of the invention as set forth in the claims.

What is claimed is:

1. A method for integrating dynamic polling mechanisms into software applications, comprising:
providing polling information for storage on a poll engine accessible via a communication network;
inserting a poll command into an interactive software application at one or more poll points, each poll point being defined by a respective interaction step of said software application;
generating a poll request message in response to target user interaction with said software application at said one or more poll points;
communicating said poll request message to said poll engine via said communication network;
generating a poll at said poll engine in response to said poll request message; and
communicating said poll to said target user via said communication network.

2. A method in accordance with claim 1, wherein said polling information includes at least one of poll titles, poll questions, poll formatting information, possible responses to said poll questions, target user types for each poll, location of a resource containing information identifying each target user, user information, a counter indicating a number of times said poll is served and the number of poll responses received, or the poll points at which particular poll questions should appear.

3. A method in accordance with claim 1, further comprising:
communicating user responses to said poll to said poll engine; and
storing said responses at said poll engine.

4. A method in accordance with claim 3, wherein said poll engine stores at least one of the content of the poll response, the identity of the user, target user IP address, poll response, identity of the polling entity, identity of the poll, date and time of poll response, or user comments.

5. A method in accordance with claim 1, further comprising:
analyzing responses to said polls.

6. A method in accordance with claim 1, wherein said poll engine comprises a plurality of databases, each of which is associated with a respective polling entity and contains polling information provided by said respective polling entity.

7. A method in accordance with claim 6, wherein said poll request message comprises at least one of the Uniform Resource Locator (URL) of a page within the software application corresponding to a location of the poll point, a user cookie, a browser type, a user's logon identification, a domain of the polling entity, or a target user certificate.

8. A method in accordance with claim 1, wherein said poll engine generates a list of possible polls based on at least one of an identity of a polling entity, user information, a poll expiration date, or poll point location.

9. A method in accordance with claim 8, further comprising:
querying response records of the user to determine response history.

10. A method in accordance with claim 9, further comprising:
selecting a specific poll from the list of possible polls to communicate to the user based on said response history.

11. A method in accordance with claim 10, wherein said selection of said specific poll is based on at least one of: (i) the user's specific response to previous polls; (ii) the user's overall response rate; (iii) the user's response rate to particular polls; (iv) a least served poll; or (v) poll expiration date.

12. A method in accordance with claim 10, further comprising:
storing a serve record.

13. A method in accordance with claim 12, wherein said serve record comprises at least one of an identity of the poll served, the identity of the target user, date and time of poll, poll point identification, or IP address of target user.

14. A method in accordance with claim 10, wherein said communicating said poll to said user further comprises:
generating a command based on a browser type used by said user and said polling information, said command enabling said poll to be displayed on said browser; and
communicating the command to the browser.

15. A method in accordance with claim 10, further comprising;
creating a new record for said user in said database if the user cannot be identified.

16. A method in accordance with claim 10, further comprising:
creating a response record indicating at least one of the identity of the polling entity, an identity of the poll served, poll point identification, the identity of the target user, poll response, user comments, target user IP address, or date and time of the poll response.

17. A method in accordance with claim 10, further comprising:
determining if a user is allowed to view cumulative results of the polling; and
if allowed, generating a command that displays said cumulative results on the browser;
if not allowed, generating a command that displays a predetermined message on the browser.

18. A method in accordance with claim 8, wherein:
said identity of said polling entity cannot be determined; and
a generic poll is generated and communicated to said user.

19. A method in accordance with claim 1, further comprising:
allowing a polling entity to view results of said poll;
wherein said results are compiled from one of a specific target user poll responses or a plurality of poll responses from various users.

20. A method in accordance with claim 1, further comprising:
generating reports comprising poll results.

21. A method in accordance with claim 1, wherein said poll command comprises a markup language compatible with a device accessing said software application.

22. A system for integrating dynamic polling mechanisms into software applications, comprising:
a poll engine accessible via a communication network having a database for storing polling information;
an interactive software application having a poll command inserted at one or more poll points, each poll point being defined by a respective interaction step of said software application;
a browser enabling a target user to access the interactive software application via said communication network;
a user processor associated with said browser for generating a poll request message in response to user interaction with said software application at said one or more poll points and communicating said poll request message to said poll engine via said communication network; and
a poll processor associated with said poll engine adapted for generating a poll in response to said poll request message and communicating said poll to said browser via said communication network.

23. A system in accordance with claim 22, wherein said polling information includes at least one of poll titles, poll questions, poll formatting information, possible responses to said poll questions, target user types for each poll, location of a resource containing information identifying each target user, user information, a counter indicating a number of times said poll is served and the number of poll responses received, or the poll points at which particular poll questions should appear.

24. A system in accordance with claim 22, wherein:
said browser communicates user responses to said poll to said poll engine; and
said responses are stored at said poll engine.

25. A system in accordance with claim 24, wherein said poll engine stores at least one of the content of the poll response, the identity of the user, target user IP address, poll response, identity of the polling entity, identity of the poll, date and time of the poll response, or user comments.

26. A system in accordance with claim 22, wherein:
said poll processor analyzes said responses to said polls.

27. A system in accordance with claim 22, wherein said poll engine comprises a plurality of databases, each of which is associated with a respective polling entity and contains polling information provided by said respective polling entity.

28. A system in accordance with claim 27, wherein said poll request message comprises at least one of the Uniform Resource Locator (URL) of a page within the software application corresponding to a location of the poll point, a user cookie, a browser type, a user's logon identification, a domain of the polling entity, or a target user certificate.

29. A system in accordance with claim 22, wherein said poll engine generates a list of possible polls based on at least one of an identity of a polling entity, user information, a poll expiration date, or poll point location.

30. A system in accordance with claim 29, wherein said poll engine queries response records of the user to determine response history.

31. A system in accordance with claim 30, wherein said poll engine selects a specific poll from the list of possible polls to communicate to the user based on said response history.

32. A system in accordance with claim 31, wherein said selection of said specific poll is based on at least one of: (i) the user's specific response to previous polls; (ii) the user's overall response rate; (iii) the user's response rate to particular polls; (iv) a least served poll; or (v) poll expiration date.

33. A system in accordance with claim 31, wherein:
a serve record is stored.

34. A system in accordance with claim 33, wherein said serve record comprises at least one of an identity of the poll served, the identity of the target user, date and time of poll, poll point identification, or IP address of target user.

35. A system in accordance with claim 31, wherein the poll processor communicates the poll to the browser by:
generating a command based on a browser type used by said user and said polling information; and
communicating the command to the browser.

36. A system in accordance with claim 31, wherein;
a new record is created for said user in said database if the user cannot be identified.

37. A system in accordance with claim 31, wherein:
a response record is created in said database indicating at least one of the identity of the polling entity, an identity of the poll served, poll point identification, the identity of the target user, poll response, user comments, target user IP address, or date and time of the poll response.

38. A system in accordance with claim 31, wherein said poll processor:
determines if a user is allowed to view cumulative results of the polling; and
if allowed, generates a command that displays said cumulative results on the browser;
if not allowed, generates a command that displays a predetermined message on the browser.

39. A system in accordance with claim 29, wherein:
said identity of said polling entity cannot be determined; and
a generic poll is generated and communicated to said user.

40. A system in accordance with claim 22, wherein:
a polling entity is allowed to view results of said poll; and
said results are compiled from one of a specific target user poll responses or a plurality of poll responses from various users.

41. A system in accordance with claim 22, wherein said poll processor generates reports comprising poll results.

42. A system in accordance with claim 22, wherein said poll command comprises a markup language compatible with the browser.
